(19) United States
(12) Patent Application Publication
(10) Pub. No.: US 2022/0290492 A1
(43) Pub. Date: Sep. 15, 2022

(54) BLAST PROTECTED WINDOW

(71) Applicant: ISRAEL DIMRI, MOSHAV BEIT HAGDI (IL)

(72) Inventor: ISRAEL DIMRI, MOSHAV BEIT HAGDI (IL)

(21) Appl. No.: 17/671,642

(22) Filed: Feb. 15, 2022

(30) Foreign Application Priority Data
Mar. 15, 2021 (IL) 281506

(51) Int. Cl. E06B 5/12; E06B 1/12; E06B 1/60; E06B 3/46

(52) U.S. Cl. CPC E06B 5/12; E06B 1/12; E06B 1/6015; E06B 3/4609

(57) ABSTRACT

A blast-protected window, including a sash including a glass plate surrounded by a first frame, and being carried by a second frame being fixed to an opening of a structure, and a third frame, being fixed to the structure opening, and including a first peripheral surface shaped for closely covering the room side of the second frame, and being configured to block, thereby blast directed from the external environment onto the glass plate knocks onto the first peripheral surface of the third frame disposed close thereto and being configured to block the blast.

### CROSS-REFERENCE TO RELATED APPLICATIONS

This application claims the benefit of priority from Israel Patent Application No. 281506, filed Mar. 15, 2021, the disclosure of which is incorporated herein by reference.

### TECHNICAL FIELD

The invention relates to the field of blast-protected window.

### BACKGROUND

FIG. 1 is a front view of a prior art window as viewed from within a room.

The prior art window 52 includes a sash 58A including glass plate 28A being surrounded by a frame 60A, a stationary frame 20 for sliding sash 58A therealong, and being fixed to the structure opening 14, and a sash 58B including glass plate 28B being surrounded by a frame 60B being slideable along stationary frame 20.

However, even if glass plate 28A is sufficiently thick and durable against blast, slideable frame 60A and stationary frame 20, being typically of aluminum, are foldable upon the blast, thus removing glass plate 28A therefrom.

There is a long felt need to provide a solution to the above-mentioned and other problems of the prior art.

### SUMMARY

In accordance with an embodiment of the invention, a blast-protected window is provided, including a frame, being fixed to a structure opening, for closely covering the room side of a window.

### BRIEF DESCRIPTION OF THE DRAWINGS

Embodiments, features, and aspects of the invention are described herein in conjunction with the following drawings:

FIG. 1 is a front view of a prior art window as viewed from the room.

FIG. 2 is a front sectional view of a blast-protected window according to one embodiment of the invention, as viewed from the room.

FIG. 3 is a front view of the sashes and the blast blocking-frame 18 of FIG. 2, being separated from one another.

FIG. 4 is the front view of FIG. 3 according to another embodiment.

FIG. 5 is a top sectional view of the blast-protected window of FIG. 2.

FIG. 6 magnifies a side zone of the top sectional view of the blast-protected window of FIG. 2.

FIG. 7 is the top sectional view of FIG. 5 upon sliding the sashes.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

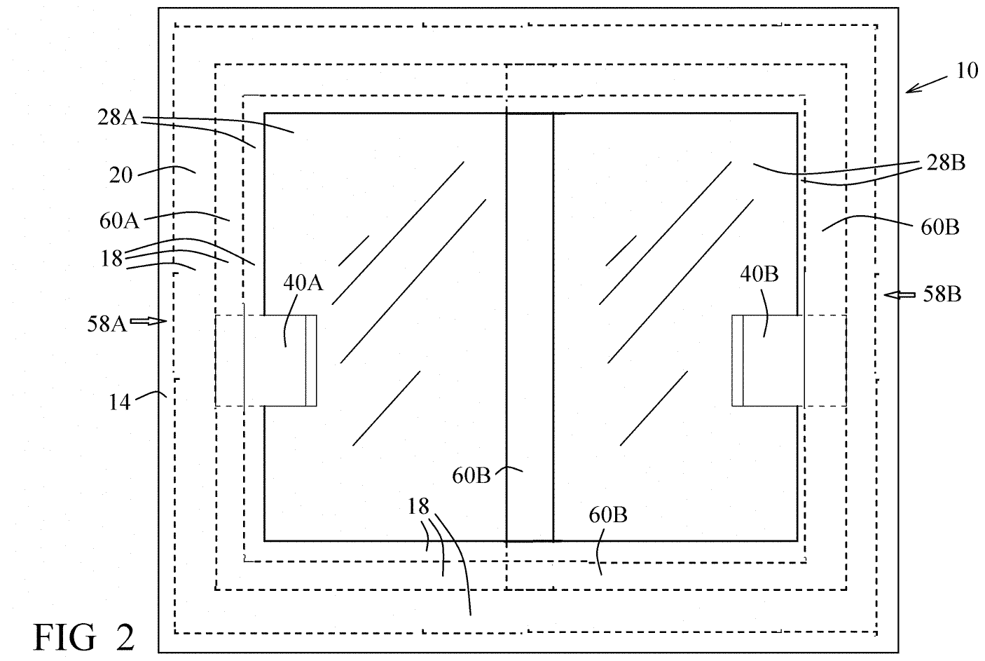

FIG. 2 is a front sectional view of a blast-protected window according to one embodiment of the invention, as viewed from the room.

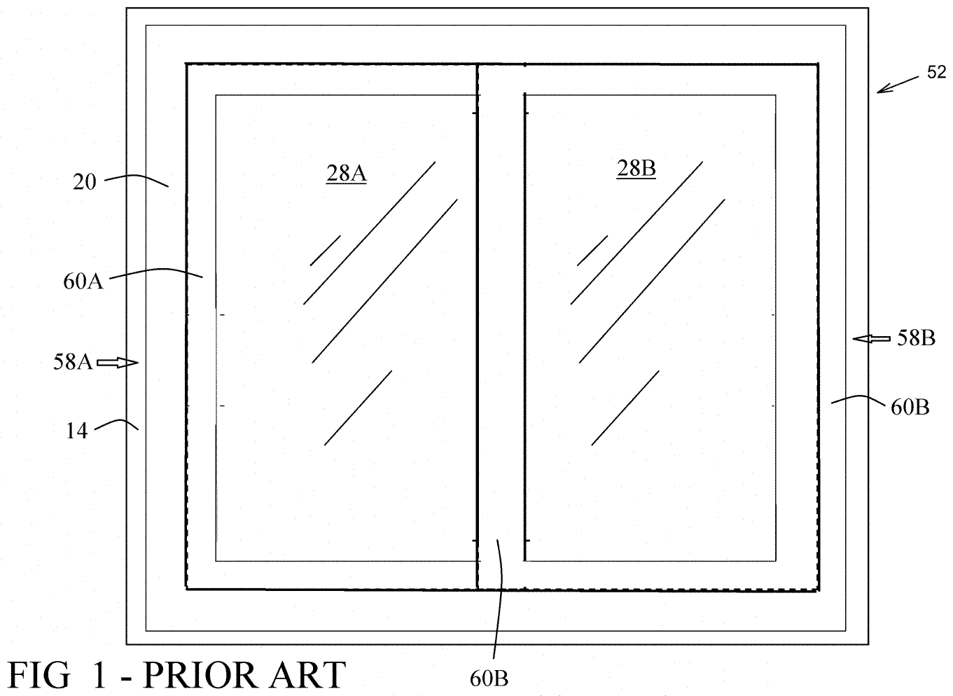

A blast-protected window 10 according to one embodiment of the invention, includes sash 58A including glass plate 28A being surrounded by frame 60A all of FIG. 1; stationary frame 20 for sliding sash 58A therealong, and being fixed to the structure opening 14; and sash 58B including glass plate 28B being surrounded by frame 60B being slideable along stationary frame 20, all of FIG. 1.

Blast-protected window 10 further includes a blast blocking-frame 18, covering, from the side of the room, stationary frame 20 and slideable frames 60A and 60B, and may further cover a small portion of glass plates 28A and 28B. Thus, stationary frame 20, slideable frames 60A and 60B, and the small portion of glass plates 28A and 28B are shown as hidden by blast blocking-frame 18, by dashed lines.

Slideable frame 60A includes a handle 40A being sufficiently long for extending beyond blast blocking-frame 18, for allowing sliding frame 60A in spite of the covering by blast blocking-frame 18.

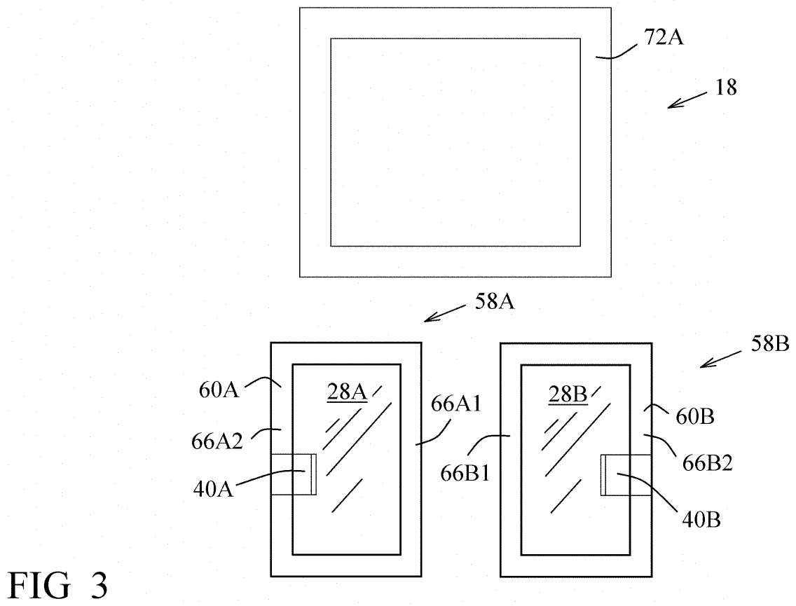

FIG. 3 is a front view of the sashes and the blast blocking-frame 18 of FIG. 2, being separated from one another.

According to this embodiment, blast blocking-frame 18 does not protect center zone 66A1 of sash 58A and center zone 66B1 of sash 58B except from the top and bottom thereof.

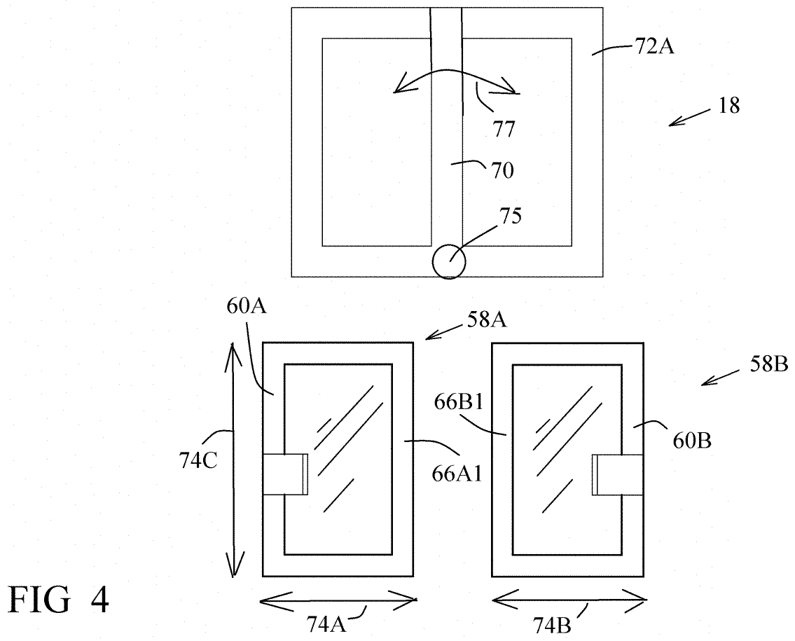

FIG. 4 is the front view of FIG. 3 according to another embodiment.

According to this embodiment, blast blocking-frame 18 includes an additional vertical bar 70, for protecting center zone 66A1 of sash 58A and center zone 66B1 of frame sash 58B along their entire height 74C.

Vertical bar 70 may be rotatable (77) via a hinge 75, for allowing folding it.

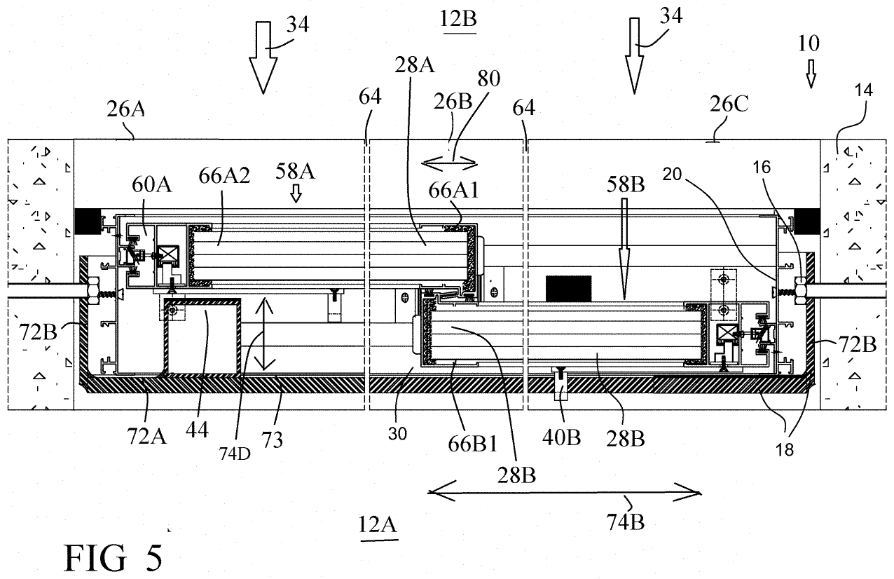

FIG. 5 is a top sectional view of the bottom of the blast-protected window of FIG. 2.

Blast blocking-frame 18 facing the room 12A protects from blast 34 entering room 12A from the external environment 12B.

Blast blocking-frame 18 is disposed very near sash 58B all along, thus the entire length 74B of sash 58B is supported by blast blocking-frame 18, thus protected from blast 34.

However, blast blocking-frame 18 is distanced from sash 58A, along most of the length of sash 58A, the distance being the thickness 74D of sash 58B.

In spite of distance 74D, center zone 66A1 zone of sash 58A is supported by center zone 66B1 of sash 58B, being supported by blast blocking-frame 18, thus center zone 66A1 zone of sash 58A is protected from blast 34.

Window 10 may be designed such that center zone 66A1 of sash 58A supporting center zone 66B1 of sash 58B includes a portion of glass plate 28B of sash 58B overlapping a portion of glass plate 28A of sash 58A.

The overlapping is even at the closed state of sashes 58A and 58B, shown in FIG. 5, in which the overlapping length 80 is smallest, thus utilizing strength of thick glass plates for protecting stationary frame 20.

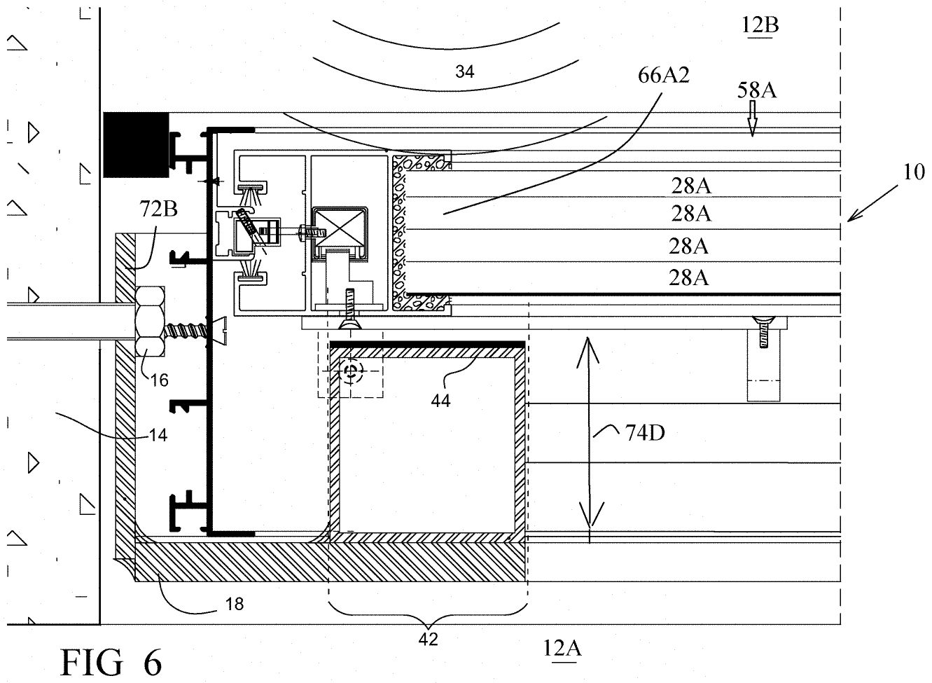

FIG. 6 magnifies a side zone of the top sectional view of the bottom of the blast-protected window of FIG. 2.

In spite of distance 74D, side zone 66A2 of sash 58A as well is protected from blast 34, since side zone 66A2 of sash 58A is supported at the closed state of sash 58A, by a protrusion 44 of blast blocking-frame 18.

According to another embodiment, protrusion 44 may extend horizontally all along sash 58A, thus not allowing sliding sash 58B.

Blast blocking-frame 18 includes a peripheral right angle extension 72B, being fixed by bolts 16 or by welding to structure opening 14, thus bolts 16 are directed perpendicular to blast 34, for blocking it by blast blocking-frame 18.

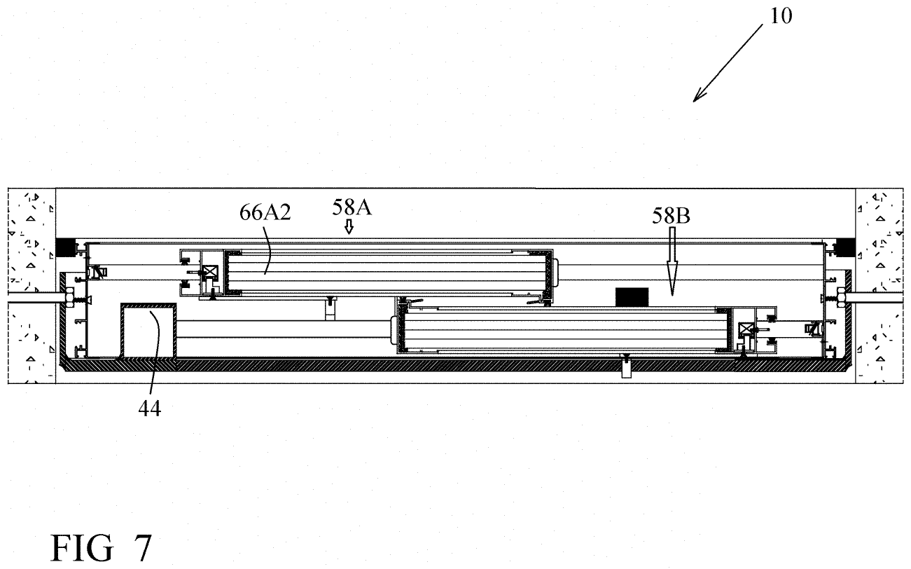

FIG. 7 is the top sectional view of FIG. 5 upon sliding the sashes.

Upon sliding sash 58A from the closed state, side zone 66A2 of sash 58A is not supported by blocking-frame 18 or by protrusion 44 thereof.

Thus, in one aspect, the invention is directed to a blast-protected window (10), including:
at least one sash (58A) including at least one glass plate (28A) surrounded by a first frame (60A), and being carried by a second frame (20) being fixed to an opening (14) of a structure; and
a third frame (18), being configured to block, and being fixed to the structure opening (14), and including a first peripheral surface (72A) shaped for closely covering a room side (73) of at least a portion of the second frame (20),
   thereby blast (34) directed from an external environment (12B) onto the at least one glass plate (28A) knocks the second frame (20) onto the first peripheral surface (72A) of the third frame (18) disposed close thereto and being configured to block the blast (34).

The first peripheral surface (72A) of the third frame (18) may further be shaped for covering at least a portion of the first frame (60A) from the room side (12A), thereby the blast (34) knocks the at least the portion of the first frame (60A) onto the first peripheral surface (72A) of the third frame (18) disposed close thereto and being configured to block the blast (34).

The first peripheral surface (72A) of the third frame (18) may further be shaped for covering at least a portion of the at least one glass plate (28A) from the room side (12A), thereby the blast (34) knocks the at least one glass plate (28A) onto the first peripheral surface (72A) of the third frame (18) being configured to block the blast (34).

The third frame (18) may include a protrusion (44) for closely covering at least a portion of the first frame (60A) being distant (74D) from the room side (73) of the second frame (20), thereby the blast (34) knocks the at least the portion of the first frame (60A) being distant (74D) from the room side (73) of the second frame (20), onto the protrusion (44) of the third frame (18) being configured to block the blast (34).

The at least one sash (58A) may include at least two sashes (58A,58B), where the first frame (60A) of at least one (58A) of the at least two sashes (58A,58B) is distant from the room side (73) of the second frame (20), and the protrusion (44) of the third frame (18) is disposed where covering the portion of the first frame (60A) upon being disposed at a closed state of the at least one (58A) of the at least two sashes (58A,58B).

The at least one sash (58A) may include at least a first sash (58A) and a second sash (58B), thereby the blast (34) directed onto the at least one glass plate (28A) of the at least first sash (58A) knocks the at least one glass plate (28B) of the at least second sash (58B) knocking the first peripheral surface (72A) of the third frame (18) disposed close thereto and being configured to block the blast (34).

The at least one sash (58A) may include at least a first sash (58A) and a second sash (58B) lengths (74A,74B) thereof being sufficiently small in relation to a length of the second frame (20) to provide that the at least one glass plate (28A) of the at least first sash (58A) and the at least one glass plate (28B) of the at least second sash (58B) overlap (30) one another even at a closed state of the sashes (58A, 58B), thereby even at the closed state of the sashes (58A, 58B), the blast (34) directed onto the at least one glass plate (28A) of the at least first sash (58A) knocks the overlapping (30) of the at least one glass plate (28B) of the at second sash (58B), knocking onto the third frame (18) disposed close thereto and being configured to block the blast (34).

The fixing of the third frame (18) to the structure opening (14) may include a peripheral right angle extension (72B) extending from the first peripheral surface (72A).

The peripheral right angle extension (72B) may be fixed by bolts (16) to the structure opening (14), the bolts (16) being directed perpendicular to the blast (34) for blocking the blast (34) by the first peripheral surface (72A) of the blast blocking-frame (18).

The first frame (60A) of the at least one sash (58A) may include a handle (40A) being sufficiently long for extending beyond the first peripheral surface (72A) of the blast blocking-frame (18).

The first peripheral surface (72A) of the third frame (18) may include at least one vertical bar (70).

In the figures and/or description herein, the following reference numerals (Reference Signs List) have been mentioned:
numeral 10 denotes the blast-protected window according to one embodiment of the invention;
12A: room side;
12B: external environment side;
14: structure opening;
16: bolt or welding;
18: frame configured to block blast, which may be rigid, such as of steel;
20: stationary frame;
28A: glass plate of sash 58A;
28B: glass plate of sash 58B;
26A,26B,26C: zones;
30: overlapping zone;
34: blast;
40A,40B: handles;
42: width of protrusion 44;
44: protrusion of blast blocking-frame 18, covering frame 60A being distant (74D) from room side 73;
52: prior art window;
58A: sash including glass plate 28A and its frame 60A;
58B: sash including glass plate 28B and its frame 60B;
60A: frame of sash 58A;
60B: frame of sash 58B;
64: indication that the sash is longer than drawn;
66A1: center zone of sash 58A, i.e., the side of sash 58A being disposed at the center of stationary frame 20 at the closed state of sash 58A;
66A2: side zone of sash 58A;
66B1: center zone of sash 58B, i.e., the side of sash 58B being disposed at the center of stationary frame 20 at the closed state of sash 58B;
66B2: side zone of sash 58B;
70: vertical bar of blocking-frame 18;
72A: peripheral surface of blocking-frame 18;
72B: peripheral extension, extending from peripheral surface of blocking-frame 18;
73: room side of stationary frame 20;
74A: length of sash 58A;
74B: length of sash 58B;
74C: height of sashes 58A,58B;
74D: thickness of sash 58A;
75: hinge;
77: rotation of vertical bar 70;
80: overlapping length.

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A blast-protected window, comprising:
at least one sash comprising at least one glass plate surrounded by a first frame, and being carried by a second frame being fixed to an opening of a structure; and
a third frame, being configured to block, and being fixed to said structure opening, and comprising a first peripheral surface shaped for closely covering a room side of at least a portion of said second frame,
thereby blast directed from an external environment onto said at least one glass plate knocks said second frame onto said first peripheral surface of said third frame disposed close thereto and being configured to block the blast.

2. The blast-protected window according to claim 1, wherein said first peripheral surface of said third frame is further shaped for covering at least a portion of said first frame from said room side, thereby said blast knocks said at least said portion of said first frame onto said first peripheral surface of said third frame disposed close thereto and being configured to block the blast.

3. The blast-protected window according to claim 1, wherein said first peripheral surface of said third frame is further shaped for covering at least a portion of said at least one glass plate from said room side, thereby said blast knocks said at least one glass plate onto said first peripheral surface of said third frame being configured to block the blast.

4. The blast-protected window according to claim 1, wherein said third frame comprises a protrusion for closely covering at least a portion of said first frame being distant from said room side of said second frame, thereby said blast knocks said at least said portion of said first frame being distant from said room side of said second frame, onto said protrusion of said third frame being configured to block the blast.

5. The blast-protected window according to claim 4, wherein said at least one sash comprises at least two sashes,
wherein said first frame of at least one of said at least two sashes is distant from said room side of said second frame, and
wherein said protrusion of said third frame is disposed where covering said portion of said first frame upon being disposed at a closed state of said at least one of said at least two sashes.

6. The blast-protected window according to claim 1, wherein said at least one sash comprises at least a first sash and a second sash, thereby said blast directed onto said at least one glass plate of said at least first sash knocks said at least one glass plate of said at least second sash knocking said first peripheral surface of said third frame disposed close thereto and being configured to block the blast.

7. The blast-protected window according to claim 1, wherein said at least one sash comprises at least a first sash and a second sash lengths thereof being sufficiently small in relation to a length of said second frame to provide that said at least one glass plate of said at least first sash and said at least one glass plate of said at least second sash overlap one another even at a closed state of said sashes, thereby even at said closed state of said sashes, said blast directed onto said at least one glass plate of said at least first sash knocks said overlapping of said at least one glass plate of said at second sash, knocking onto said third frame disposed close thereto and being configured to block the blast.

8. The blast-protected window according to claim 1, wherein said fixing of said third frame to said structure opening comprises a peripheral right angle extension extending from said first peripheral surface.

9. The blast-protected window according to claim 8, wherein said peripheral right angle extension is fixed by bolts to said structure opening, said bolts being directed perpendicular to said blast for blocking said blast by said first peripheral surface of said blast blocking-frame.

10. The blast-protected window according to claim 1, wherein said first frame of said at least one sash comprises a handle being sufficiently long for extending beyond said first peripheral surface of said blast blocking-frame.

11. The blast-protected window according to claim 1, wherein said first peripheral surface of said third frame comprises at least one vertical bar.
